(19) United States
(12) Patent Application Publication
(10) Pub. No.: US 2012/0175483 A1
(43) Pub. Date: Jul. 12, 2012

(54) LADDER STORAGE ASSEMBLY AND METHOD

(76) Inventor: Bruce Lawrence DeSautel, (US)

(21) Appl. No.: 13/425,028

(22) Filed: Mar. 20, 2012

Related U.S. Application Data
(63) Continuation-in-part of application No. 12/571,126, filed on Sep. 30, 2009.

(51) Int. Cl. F16M 13/02; B23P 17/04

(52) U.S. Cl. 248/342; 29/428

(57) ABSTRACT

A ladder storage assembly including at least one support member defining an interior, together dimensioned and configured to removably receive and support a first end of a ladder in and between an access orientation and a stored orientation, and a mounting member securing the assembly to an upper surface of a storage area. The storage assembly is structured to permit rotational movement of the first end of the ladder in moving between the access and stored orientations. A retention member connected to the support member(s) or mounting member maintain the position of the first end of the ladder. At least one securing member connected to the support surface and in spaced relation to the support member(s) releasably retains a second bottom end of the ladder in a stored orientation in which the ladder is substantially parallel to the upper support surface. A method for storing a ladder is also provided.

### CLAIM OF PRIORITY

The present application is a continuation-in-part application of previously filed, now pending application having Ser. No. 12/571,126, filed on Sep. 30, 2009, which is incorporated herein by reference in its entirety.

### BACKGROUND OF THE INVENTION

1. Field of the Invention

The present invention relates generally to storage devices, and more specifically, to a ladder storage assembly and method for storing a ladder that can be used to store different types of ladders relative to an upper surface of storage areas in a space-saving manner.

2. Description of the Related Art

Ladders, such as A-frame ladders and extension ladders, are common pieces of equipment useful in various professions, such as the construction and telecommunications industries, as well as by homeowners for household chores and maintenance. In use, the legs of a ladder are often disposed at angles from each other, as in an A-frame ladder, or relative to a support surface, and are necessarily quite long. Extension ladders may be further extendable to increase length in order to reach even greater heights. Ladders are therefore large and bulky pieces of equipment, but which must nevertheless be transported to locations for use and stored when not in use.

To reduce the footprint of space required for storage, most ladders are at least somewhat collapsible. For example, A-frame ladders collapse from an angled configuration to a flat configuration in which the legs lie flush against each other for storage. This reduces some dimension of the space the ladder takes up, but it is still quite long. Extension ladders may be similarly collapsible, and may further have telescoping legs that collapse longitudinally to reduce some of the length. However, the legs are not fully collapsible and the base ladder therefore still requires a fair bit of space for storage.

A common storage solution for ladders is simply to lean them, in a collapsed configuration, against a wall or periphery of a storage space such as a garage or work room. However, ladders so positioned may be easily bumped, knocked over, and can cause damage to surrounding objects if they fall as a result of being jarred. Other existing storage solutions include providing brackets, hooks, or the like on walls of the storage area on which the ladder may be placed and suspended from the floor. For example, the brackets or hooks may be positioned to support a top end of the ladder in a folded configuration, so that the ladder hangs vertically from the bracket or hook and flush against the wall. Similarly, a plurality of brackets or hooks may be positioned to support portions of the top and bottom of the ladder so that the ladder hangs sideways and flush along the wall. However, with these solutions, the ladder must be already positioned parallel with the wall when it is placed in the brackets or hooks. This can be difficult and cumbersome for one person to accomplish alone given the bulk and weight of a typical ladder, particularly if the ladder is being stored on its side. Indeed, it is typical that two people are required to lift a ladder for storage on hooks in a horizontally suspended fashion along a wall. Even once placed, the ladder takes up valuable space along the wall which precludes the storage of other useful items, and is especially problematic in view of the large size of ladders. Moreover, in order to maintain access to a ladder stored on a wall, the number and size of other items that can be stored in and around the ladder, even along the floor, is limited.

It would therefore be beneficial to have a way to store ladders in such a way that would economize storage space, allowing for further storage of other items, and yet still permit sufficient access to the ladder when it is needed. It would also be beneficial for a ladder storage solution to be easily utilized by one person alone.

### SUMMARY OF THE INVENTION

The present invention is directed to a ladder storage assembly and method for storing a ladder that minimizes the space required to store a ladder, thus creating more room for storage of additional items in a storage space, and which can easily be used by one person. Specifically, the present storage assembly provides a storage solution in which a ladder is stored substantially parallel or adjacent to an upper surface of the storage area, such as a ceiling. The storage area can be any space that is used for storage and would accommodate a ladder, such as for example a garage, shed, work room, interior of a work vehicle, etc. Moreover, the ladder can be placed in and removed from the storage assembly of the present invention by one person, since it is structured to permit rotational movement of the ladder, as will be described in greater detail hereinafter.

More in particular, the ladder storage assembly of the present invention comprises at least one support member defining an at least partially open interior. The interior space is dimensioned and configured to removably receive a first end, such as the head, of a ladder therein. The support member(s) and interior are cooperatively structured and configured to support the first end of the ladder in both an access orientation and a stored orientation. Specifically, in the access orientation the first end of the ladder can be inserted and removed from the ladder storage assembly, and the ladder may be disposed at an angle so that the top end, such as the platform in an A-frame ladder, can be placed on and removed from the support member(s) with relative ease by a single person. The separate and distinct stored orientation is at least partially defined by the ladder being disposed substantially parallel and/or adjacent to an upper surface of a storage area. As can be appreciated, since the ladder is non-parallel to a storage surface in the access orientation and substantially parallel to the storage surface in a stored orientation, the ladder storage assembly is configured to support the first end of the ladder in and between the access and stored orientations. Moreover, the storage assembly is configured to permit maneuvering and/or positioning the ladder between these positions, such as by rotational movement of the first end of the ladder. Therefore, a single person can insert a first or top end of a ladder into the present storage assembly at a non-parallel disposition to the storage surface, such as at an angle, upon which the first end of the ladder will be supported on the support member(s) of the assembly, and then move a second bottom end of the ladder toward the surface of the storage area. This movement causes the first end of the ladder to rotate within the ladder storage assembly.

In some embodiments, the support member of the ladder storage device is shaped in a cage or cradle-like configuration in which the first end, or top, of a ladder is received and retained and can be rotated within during positioning between an access orientation and a stored orientation. In some embodiments there are a plurality of support members that collectively comprise such a cradle-like structure.

In other embodiments, there are a plurality of support members structured to receive and removably support the legs of a ladder, such as an extension ladder. Each of these support members is movable relative to the support surface while simultaneously supporting the legs of the ladder, and is selectively positionable between an access orientation and a stored orientation. For example, the support members may be pivotable to facilitate rotation of the first end of the ladder between the different orientations. Accordingly, the ladder storage assembly may also include a pivoting mechanism having a plurality of pivoting members that interconnect the support members to a mounting member to facilitate the pivoting motion of the support members.

The ladder storage assembly further includes a mounting member secured to a support surface of the storage area, such as a ceiling, beam, or other similar structure located in the upper portion of the storage area. The support member(s) is connected in suspended, depending relation to the mounting member and extends into the storage area space.

In additional embodiments, the ladder storage assembly also includes at least one retention member structured to maintain the position of the first end of a ladder disposed on the support member(s), so as to prevent the ladder from slipping out of the storage assembly. This retention member may comprise a lip connected to the support member(s), and/or a stabilizing hoop connected to the mounting member.

Moreover, in further embodiments the ladder storage assembly comprises at least one securing member connected in depending relation to the support surface or mounting member, and is disposable to releasably retain at least a portion of the second end of the ladder, the bottom end, in a stored orientation. For example, the securing member(s) may be a strap mounted to the support surface, such as the ceiling or beam, and which at least partially encircles a rung, side, or circumference of the ladder near the bottom end of the ladder.

These and other objects, features and advantages of the present invention will become clearer when the drawings as well as the detailed description are taken into consideration.

### BRIEF DESCRIPTION OF THE DRAWINGS

For a fuller understanding of the nature of the present invention, reference should be had to the following detailed description taken in connection with the accompanying drawings in which:

FIG. 1 is a side perspective view of an embodiment of the ladder storage assembly of the present invention, shown supporting an A-frame ladder in an access orientation.

FIG. 2 is a front perspective view of the ladder storage assembly of FIG. 1.

FIG. 3 is a perspective view of one embodiment of the ladder storage assembly of FIG. 1.

FIG. 4 is a side plan view of the ladder storage assembly showing a stored orientation.

FIG. 5 is a perspective view of another embodiment of the ladder storage assembly of the present invention, shown supporting an extension ladder.

FIG. 6 is a front perspective view of the ladder storage assembly of FIG. 5.

FIG. 7 is a perspective view of one embodiment of the ladder storage assembly of FIG. 5.

Like reference numerals refer to like parts throughout the several views of the drawings.

### DETAILED DESCRIPTION

The present invention is directed to a ladder storage assembly and method for storing a ladder that minimizes the space required to store a ladder and which can easily be utilized by one person. The ladder storage assembly can be used to secure ladders such as, but not limited to, A-frame and extension ladders, to an upper surface of a storage area, such as substantially parallel to the ceiling of a garage or other storage area. Generally, the storage assembly of the present invention removably receives and supports the top end of a ladder, for example the head of an A-frame ladder or the legs of an extension ladder, in and between an access orientation and a stored orientation. The assembly is structured to permit the ladder, once inserted, to be positioned and/or rotated between the two orientations.

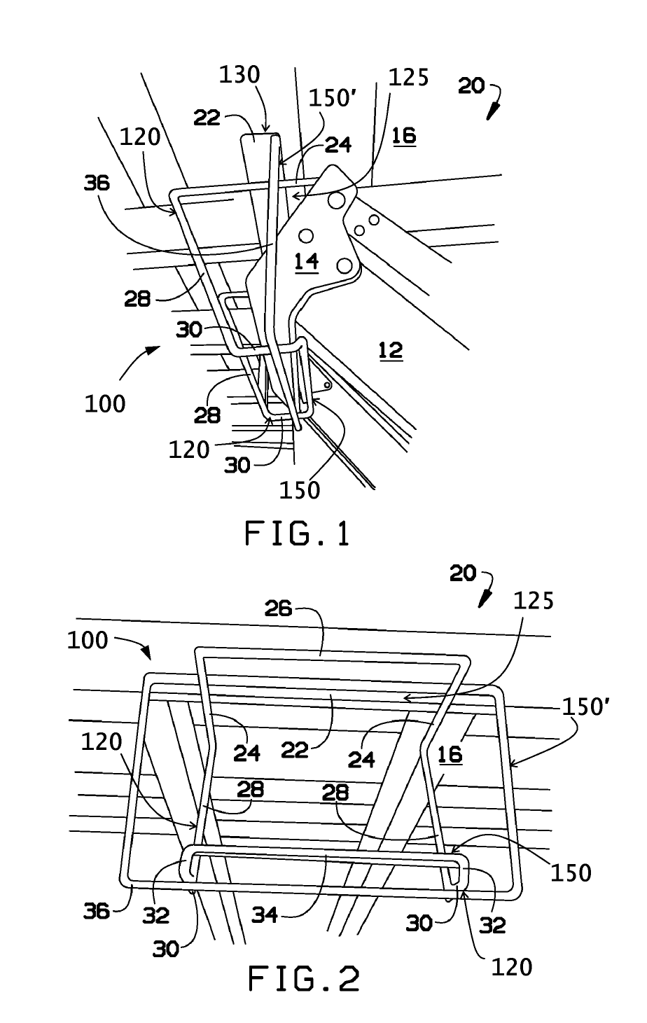

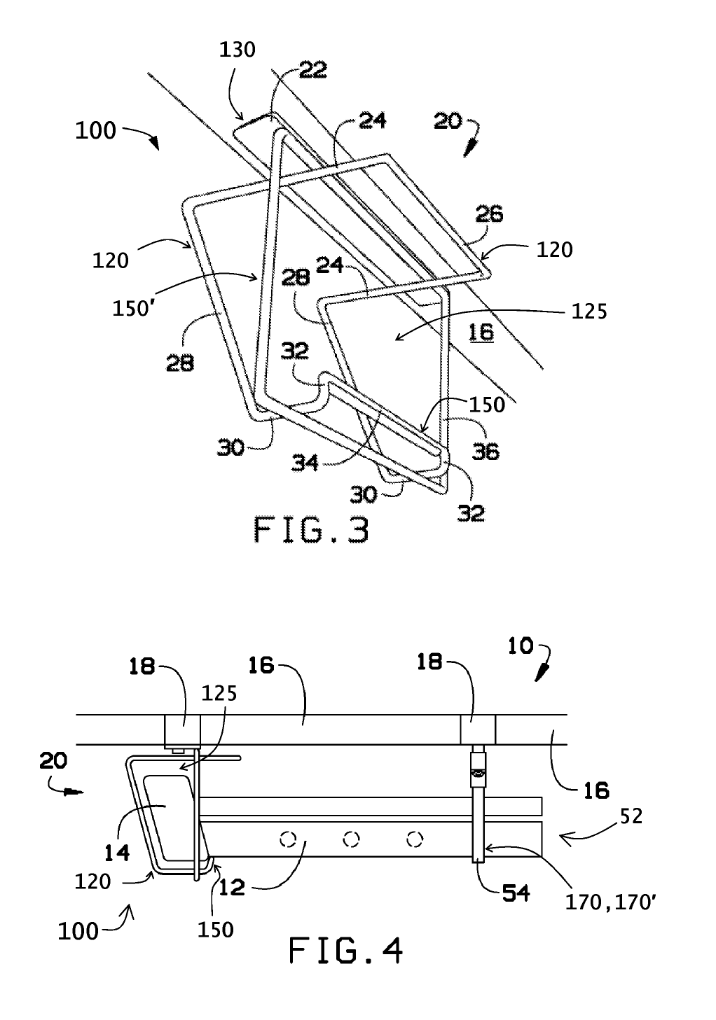

As shown throughout the Figures, the ladder storage assembly 100 of the present invention comprises at least one support member 120 defining an at least partially open interior 125. The interior 125 is dimensioned and configured to removably receive a first end 14 of a ladder 12 therein. For example, as depicted in FIGS. 1-3, the at least one support member 120 may be configured to form a ladder end cradle 20, or other similar type structure, for receiving and supporting the first end 14 of a ladder therein. FIG. 1 shows the ladder storage assembly 100 utilized with an A-frame ladder 12, although other types of ladders may also be used. The ladder storage assembly 100 may comprise a single continuous support member 120, such as formed of a one-piece construction, or a plurality of support members 120 collectively structured and configured to define an at least partially open interior 125 space.

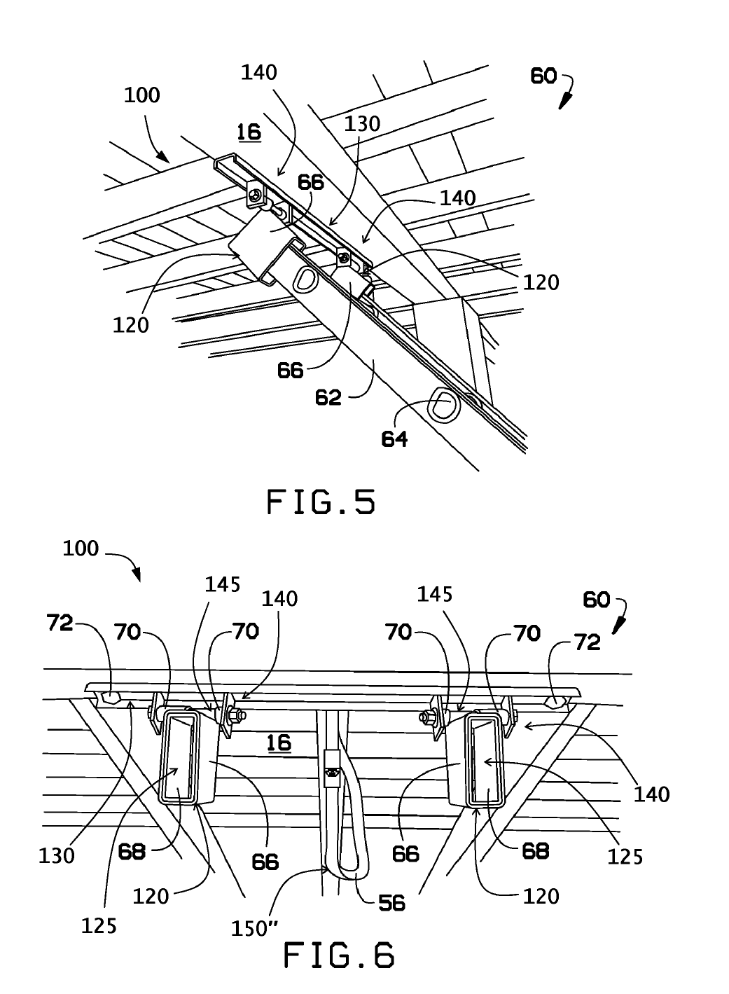

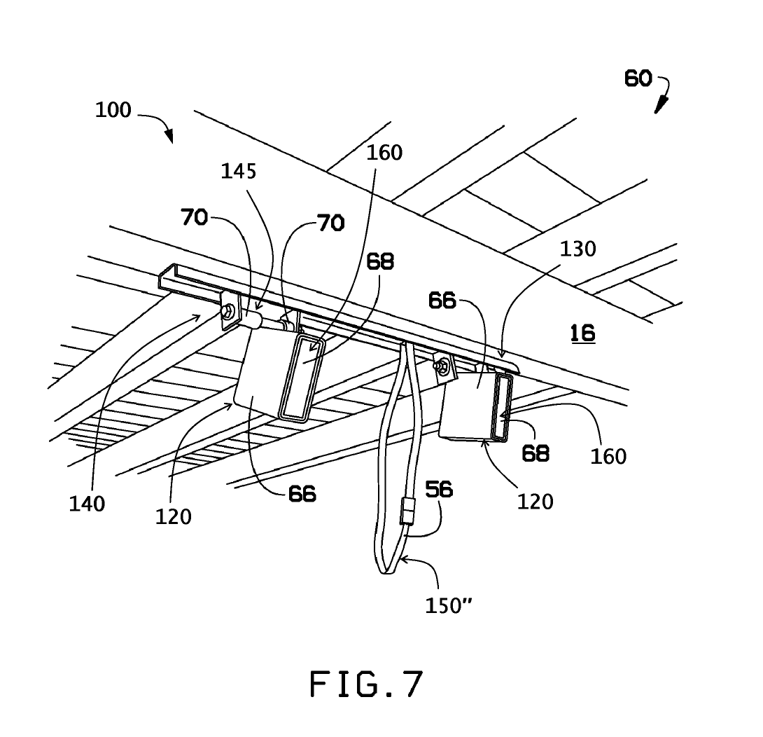

For example, as seen in FIGS. 1-3, the plurality of support members 120 may be joined or formed together to collectively define a cradle-type structure 20. The plurality of support members 120 may include horizontal top bars 24, preferably two, that are perpendicular and/or transverse to the axis of a mounting member 130, discussed in greater detail hereinafter, such as a mounting plate 22, and parallel to the plane of the mounting plate 22 and the ceiling or other upper support surface 16 of the storage area. The top bars 24 may be spaced apart a distance less than, equal to, or greater than the width of a ladder 12, such as spaced approximately 10.5 inches apart and recessed in from the edges of mounting plate 22 by approximately 2 inches. The top bars 24 extend beyond the mounting plate 22 sufficiently to provide stability to the ladder storage device 100. In one example, the top bars 24 extend forward of the mounting plate 22 approximately 2.5 inches, and behind the plate, such as by approximately 3.5 inches. The support members 120 may further include a transverse top bar 26 which connects the two top bars 24 together. The top bars 24 may be angled downward from the ceiling 16 or upper support surface of the storage area, such as at approximately a 30° angle or other angle, to form two downward bars 28. This angle may coincide with the angle of the folded ladder head 14, although it may comprise any angle. In one embodiment, the downward bars 28 are approximately 9 inches long, although they may be any length appropriate to accommodate the size of the ladder head 14. At the end of the downward bars 28 closest to floor when the storage assembly 100 is mounted to the ceiling 16, or otherwise opposite of the support surface 16 of the storage area, the support member(s) 120 is bent at approximately a 60° or other appropriate angle, thus forming bottom bars 30 which are parallel to the upper surface of the storage area when the ladder storage assembly 100 is mounted thereto. For example, when the ladder storage assembly 100 is mounted to the ceiling 16, the bottom bars 30 may be substantially horizontal and parallel to the ceiling 16. Moreover, the bottom bars 30 are at least long enough to accommodate a front side of the head 14 of the ladder 12, as shown in FIG. 1. For example, in one embodiment the bottom bars 30 extend approximately 2.5 inches. The bottom bars 30 may further be bent upward toward the ceiling, such as at approximately a 90° angle, to form upward bars 32. The upward bars 32 extend approximately 1 inch in one example, although other lengths that are sufficient to catch the first end 14 of the ladder 12 are within the spirit of the present invention. In other embodiments, such as shown in FIGS. 5-7 in which an extension-type ladder 62 can be stored, the plurality of support members 120 are collectively structured to removably support a first end of a ladder and comprise an open interior 125 dimensioned and configured to removably receive correspondingly disposed legs 64 of the first end of the ladder 62. For instance, at least two of the support members 120 comprise an open interior 125 each dimensioned to receive a different corresponding leg 64 of the first end of the ladder. In such embodiment, each of the support members 120 may comprise a closed loop configuration, such as a rectangular tube 66.

The ladder storage assembly 100 may be made from any material sufficiently strong to support a ladder thereon, such as steel or plastic by way of example. For instance, the support member(s) 120 may be made of plastic or nylon, and may be formed by injection molding or other suitable methods. They can also be made of metal, such as round metal stock, in which the individual pieces are bent and welded together to form a one-piece construction.

The ladder storage assembly 100 of the present invention further comprises a mounting member 130 that is connected and/or otherwise secured to an upper support surface 16 of the storage area. By way of example only, the mounting member 130 may be screwed, nailed, bolted, or otherwise fixedly attached to the upper support surface, and yet may be removable from the support surface if desired, such as when the ladder storage assembly 100 is no longer needed. The support member(s) 120 is connected in suspended, depending relation to the mounting member 130 such that the support member(s) 120 is suspended from the upper support surface 16 and extends into the storage area space. Accordingly, and as can be appreciated from the Figures, one surface of the mounting member 130 is disposed in confronting engagement with the support surface 16, and a different surface, such as an opposing surface, of the mounting member 130 is disposed in confronting engagement with the support member(s) 120. Moreover, the mounting member 130 may be any size and shape as will be able to secure the support member(s) 120 to the upper surface. For instance, in the embodiment of FIGS. 1-3, the mounting member 130 comprises a mounting plate 22, which may be approximately 14.5 inches long and 2 inches wide, or other appropriate size in view of the ladder to be supported and the dimensions and configuration of the support member(s) 120. In another embodiment, as shown in FIGS. 5-7, the mounting member 130 comprises a more elongate shape, such as a track.

The ladder storage assembly 100, and specifically the support member(s) 120 and interior 125, are configured to support a first end 14 of a ladder in and between an access configuration and a stored orientation. In the access orientation, as depicted in FIGS. 1 and 5, the head of a ladder can be inserted and removed from the ladder storage assembly 100. The access orientation may be defined by the ladder storage assembly 100 positioned to permit a ladder to be disposed thereon in an angled disposition relative to the upper support surface 16 of the storage area, in order to facilitate loading and unloading of the ladder from the ladder storage assembly 100. As used herein, “angled” means a measurement other than parallel, and may include any of a plurality of angles. Accordingly, in the access orientation the first end 14 of a ladder is supported on the support member(s) 120 of the ladder storage assembly 100, and the second 52 or bottom end of the ladder (not shown) is near to the floor of the storage area or ground.

In contrast, the stored orientation, an example of which is shown in FIG. 4, is defined by the ladder storage assembly 100 positioned to support the ladder disposed thereon in substantially parallel relation to the upper support surface 16. It should be understood that as used herein, the term “parallel” should not be strictly interpreted, but is meant to include an orientation of the ladder wherein its length is substantially aligned or equally spaced from the support surface or structure. As such the ladder can be disposed in an offset or at least partially angular relation to the support surface rather than be in a true parallel relation thereto. Accordingly, the term “parallel” is meant to include slight variations in the orientation of the ladder from a true and precise parallel relation to the support surface. Moreover, the upper support surface 16 need not be horizontal, and may be an angled surface. In such case, the ladder in the stored orientation is still disposed substantially parallel to the support surface 16, even though this may result in an angled disposition. It can therefore be said that in the stored orientation, the first end 14 of the ladder is supported on the support member(s) 120 of the ladder storage assembly 100, and an opposite second end 52, being the bottom of the ladder, is disposed near to or in proximity to the upper support surface 16.

Accordingly, the ladder storage assembly 100 is also structured to permit rotational movement of the first end 14 of the ladder supported therein between an access orientation and a stored orientation. For instance, in the embodiment shown in FIGS. 1-4, the support member(s) 120 comprises a cradle 20 configuration which itself is stationary. However, the support member(s) 120 and the interior 125 defined thereby are cooperatively structured to permit rotational movement of a first end 14 of the ladder supported thereon when moving between the access orientation and stored orientation. More in particular, when the first end or head 14 of the ladder is placed in the ladder storage assembly 100 in an access orientation, and the body of the ladder is swung or moved to a stored orientation, the head 14 of the ladder rotates freely within the cage or cradle 20 of the support member(s) 120. The same is true in the reverse case, in which the ladder is moved from a stored orientation back to an access orientation for removal from the storage assembly 100. The support member(s) 120 and interior 125 are therefore sufficiently sized and dimensioned to permit the first end 14 of the ladder to freely rotate therein while still supporting and maintaining the head 14 of the ladder.

In the embodiment of FIGS. 5-7, the ladder storage assembly 100 permits rotational movement of the first end 14 of a ladder differently. Specifically, the support members 120 are themselves movable relative to the upper support surface 16 while simultaneously and concurrently supporting the legs 64 of the ladder therein. For example, the support members 120 may be pivotally connected to the mounting member 130 so that they may move by pivoting action and be rotated upward and downward. To this end, the ladder storage assembly 100 may further comprise a pivot mechanism 140 having a plurality of pivot members 145, such as hinges 70 or other suitable structure, interconnecting the support members 120 with the mounting member 130. As seen in FIG. 6, each support member 120 is associated with a different pivot member 145 to pivotally connect it to the mounting member 130, such that each support member 120 is selectively movable concurrently with the first end 14 of the ladder. The support members 120 therefore permit and even facilitate rotational movement of the first end 14 of the ladder relative to the support surface, and together are selectively positionable between an access orientation and a stored orientation.

In at least one embodiment, the ladder storage device 100 may also include at least one retention member 150 structured to maintain the position of the first end 14 of the ladder on the support member(s) 120, as shown throughout the Figures. Accordingly, the retention member 150 keeps the ladder head 14 within the storage assembly 100, such as by engaging the ladder head 14 and preventing it from sliding off or out of the storage assembly 100 unintentionally. For instance, as shown in FIGS. 1-3, the retention member 150 may be connected in depending relation to the support member(s) 120, as in the case of a retaining lip 34, which may be double welded. Specifically, the retention member 150 may be connected to and depend from the ends of the upward bars 32, thus spanning the diameter of the ladder storage assembly 100, preferably at the opening of the interior 125. The retention member 150 is further structured to extend in partially obstructing relation to the opening of the interior 125 such that it engages with the first end 14 of the ladder, having been placed within the ladder storage assembly 100 and supported on the support member(s) 120, and prevents the first end 14 of the ladder from sliding out of the storage assembly 100. However, the retention member 150 only partially, and minimally, obstructs the opening of the interior 125, so that the first end 14 of the ladder may easily be placed into and removed from the storage assembly 100. In this manner, the retention member 150 and support member(s) 120 are collectively disposed and configured to receive and retain the head 14 of the ladder.

Moreover, at least one of the retention member(s) 150′ may be connected in depending relation to the mounting member 130, as in the case of a stabilizer or stabilizing hoop 36 shown in FIGS. 1-3. Such retention member 150′ is structured and disposed in movement restricting relation to the first end 14 of the ladder to brace the first end 14 of the ladder on the support member(s) 120. This disposition limits lateral or sideways movement of the first end 14 of the ladder in the storage assembly 100, and prevents the first end 14 from slipping out of, or falling off of, the ladder storage assembly 100. As seen in FIGS. 1-3, the stabilizing retention member 150′ is attached to the mounting member 130, and may be disposed exterior of the support member(s) 120, such as to at least partially surround the support member(s) 120 and interior 125. In the particular embodiment of FIGS. 1-3, at least a part of the retention member 150′ extends parallel to the mounting member 130, turns downward at the outside edges of the mounting member 130, and extends downward toward the bottom of the bent bars and returning to meet underneath the ladder storage assembly 100. This creates a rectangular hoop 36 that keeps the ladder head 14 in place should it be hit or jarred. Such retention member 150′ also centers the ladder head 14 on the ladder storage assembly 100 for ease of use. The ladder storage assembly 100 may further include additional lateral stabilizing bars (not shown) that press against the ceiling 16 to stabilize and give lateral support to the ladder storage assembly 100.

Turning to FIGS. 5-7, the at least one retention member 150″ may be movably attachable to the first end 14 of the ladder and cooperatively disposed to restrict detachment of the legs 64 of the first end 14 of the ladder from the support member(s) 120. As seen therein, such as for use in storing an extension ladder 62, the retention member 150″ may take the form of a security strap 56 that wraps around or is secured to the first rung of the ladder. This will hold the ladder tight to the receiver or ladder storage assembly 100 and prevent the ladder from slipping out in case someone pulls on the ladder. It may also prevent the ladder from falling out of the receiver or ladder storage assembly 100. The retention member 150″ may be affixed to the mounting member 130 or other portion of the ladder storage assembly 100.

To further keep the first end 14 of a ladder from unintentionally slipping out of the storage assembly 100, at least one of the plurality of support members 120 may comprise an adjustment member 160, which may be in the form of a bushing or like structure, to provide an optimized fit for different sized ladder legs 64 within the support members 120. Specifically, and as seen in FIGS. 5-7, the adjustment member 160 is disposed within the interior 125 in confronting relation to a corresponding leg 64 of the first end 14 of the ladder. Indeed, multiple support members 120 may each have a separate adjustment member 160 associated therewith, disposed in confronting relation with different corresponding legs 64 of the first end 14 of the ladder accordingly. The adjustment members 160 are dimensioned to facilitate a fitting or snug engagement of the ladder leg 64 with the support member(s) 120, such as in the tube 66 configuration. Since different ladder legs may come in different sizes, the adjustment member 160 may be modified and/or adjustable, such as by expanding and/or contracting, to provide a better or more engaging fit with the ladder leg 64. In addition, there may be several adjustment members 160 per each support member 120 that collectively adjust ad/or can be combined to span the distance between the edge of the support member 120 and the leg 64, to accommodate ladders of different leg widths. The adjustment member 160 may comprise any appropriate material, with examples including plastic and nylon.

With reference now to FIG. 4, the ladder storage assembly 100 may further comprise at least one securing member 170, such as strap 54, which is disposable to releasably retain at least a portion of the second end 52, or bottom, of the ladder in a stored orientation. FIG. 4 shows one example of the stored orientation using an A-frame ladder, although it should be appreciated that other types of ladders and other embodiments and/or configurations of the support member(s) 120 can also be used with the securing member(s) 170.

Accordingly, the securing member(s) 170 is located a spaced distance from the support member(s) 120, such as a distance of substantially the length of a ladder. The precise distance separating the support member(s) 120 and the securing member(s) 170 may be the substantially the entire length of the ladder or a shorter length thereof, but is at least half the distance from the first end 14 of the ladder to the opposite second end 52. In one embodiment, the distance is approximately the length from the head 14 of a ladder to its furthest rung located near the bottom 52 of the ladder.

Moreover, the securing member(s) 170 connects in depending relation to the upper support surface of the storage area, and extends between the upper support surface 16 and the second end 52 of the ladder which it retains and supports in the stored orientation. Specifically, the stored orientation is at least partially defined by the securing member(s) 170 disposed in supporting relation to the second end 52 of a ladder such that the ladder is substantially parallel to the support surface 16. As before, it should be appreciated that “substantially parallel” should not be strictly construed to mean precisely parallel, but encompasses and includes slight variations thereof. In some embodiments, the securing member(s) 170 may be sufficiently long that the ladder, though substantially parallel to the support surface 16, is not necessarily in contact with or even in close proximity to the support surface 16. In other embodiments, the securing member(s) 170 have a shorter length, so as to hold the second end 52 of the ladder in proximity to the upper surface 16 of the storage area in the stored orientation, including even contacting relation with the upper surface 16 in some cases, though this is not required.

Further, the securing member(s) 170 is disposable in at least partially encircling relation to a portion of the second end 52 of the ladder in order to retain the ladder in the stored orientation. Indeed, a plurality of securing members 170 can each be disposed to releasably retain different portions of the second end 52 of the ladder, such as around a rung or rungs of the ladder, and/or around the circumference of the ladder frame. For example, a securing member 170 or strap can be placed around the center of the last rung of the ladder. This securing member 170 is closed when the ladder is first elevated to the resting position, and it can be secured with one hand since the receiving end of the securing member 170 is locked into place. For example, a receiving buckle may be integrated into a mounting bracket securing the securing member 170 to the upper support surface 16, and the securing member 170 extends down and encircles the bottom rung of the ladder before being buckled. The tail of the securing member 170 can then be cinched tight to hold the ladder in place before a secondary securing member 170′ is fastened. In some embodiments, a second securing member 170′, such as strap 54, may also be present which reaches across the entire ladder from one side to the other as a final strap. To facilitate this, brackets may be placed on the outside area of the ladder and will accommodate the second securing member 170′ as it comes from one side of the ladder to the other. However, there need not be brackets for the second securing member 170′, which may instead simply wrap around the circumference of the second end 52 of the ladder. This securing member 170′ may be secured using both hands, after the first securing member 170 is in place. For example, it may fasten, such as by buckle, in the center of the ladder for ease of attachment and removal.

Moreover, the securing member(s) 170 may be made of nylon, plastic, or other similar material suitable for suspending the weight of a ladder, and may include snaps, clasps, buckles or other mechanisms for fastening the securing member(s) 170 in position.

As noted previously, the present invention allows a single user to both load and remove a ladder from storage without additional assistance. In the method of storing a ladder of the present invention, to load a ladder, the first end 14 of a ladder is placed in the ladder storage assembly 100 in an access orientation. This may be accomplished by moving the first end 14 of the ladder into the interior 125 and positioning the front edge, or part of the head 14 of the ladder that faces a person during use, on the support member(s) 120. The bottom of the ladder may be resting on the ground or dangling downward if the ceiling or support surface 16 is higher than the ladder is tall. With the first end 14 of the ladder thus supported on the support member(s) 120 in an angled orientation relative to the upper support surface, the user is free to move to the second end 52 or bottom part of the ladder and maneuver, position, swing, or otherwise draw the second end 52 of the ladder toward the upper surface 16 of the storage area, such as the ceiling. During this motion, the ladder head 14 rotates and/or pivots in the ladder storage assembly 100, either within stationary support member(s) 120 in a cradle 20, or by directing the pivoting of the support members 120 as facilitated by a pivot mechanism 140 and pivot members 145 as previously described. Once positioned substantially parallel to the upper surface 16 of the storage area, and while holding the ladder in place with one hand, the other hand can be used to fasten the securing member(s) 170 to the bottom end 52. For instance, a first securing member 170, such as a strap, may be positioned around the last rung of the ladder, and a second securing member 170, such as strap 54, is then fastened to secure the ladder at rest in the stored orientation.

To remove ladder, the securing member(s) 170 is unfastened, the second end 52 or bottom of the ladder is lowered, once again returning the ladder to an access orientation. The ladder is then lifted out of and/or removed from the support member(s) 120 of the ladder storage assembly 100. This too may be accomplished by a single user.

While the above description explains manual manipulation of a ladder, any other method of maneuvering the ladder into and out of the ladder storage assembly 100, and between the access orientation and stored orientation, may be implemented. For example, a winch and pulley system could be applied at the base end 52 of the ladder to raise and lower the ladder if necessary.

Since many modifications, variations and changes in detail can be made to the described preferred embodiment of the invention, it is intended that all matters in the foregoing description and shown in the accompanying drawings be interpreted as illustrative and not in a limiting sense. Thus, the scope of the invention should be determined by the appended claims and their legal equivalents.

Now that the invention has been described,

What is claimed is:

1. A ladder storage assembly comprising:
at least one support member defining an at least partially open interior,
said interior dimensioned and configured to removably receive a first end of a ladder therein,
a mounting member secured to a support surface of a storage area,
said at least one support member connected in suspended relation to said mounting member, and
said at least one support member and said interior cooperatively structured and configured to support the first end of the ladder in and between an access orientation and a stored orientation.

2. The storage assembly as recited in claim 1 further comprising at least one retention member structured to maintain the position of the first end of the ladder on said support member in either said access orientation or said stored orientation.

3. The storage assembly as recited in claim 2 wherein said at least one retention member is connected in depending relation to said at least one support member.

4. The storage assembly as recited in claim 2 wherein said at least one retention member is connected in depending relation to said mounting member.

5. The storage assembly as recited in claim 2 wherein said at least one retention member comprises a stabilizer disposed exteriorly of said at least one support member and in movement restricting relation to the first end of the ladder.

6. The storage assembly as recited in claim 5 wherein said stabilizer is disposed and structured to at least partially surround said at least one support member and said interior.

7. The storage assembly as recited in claim 1 comprising a plurality of support members collectively structured to define said at least partially open interior therein.

8. The storage assembly as recited in claim 1 further comprising at least one securing member connected in depending relation to the support surface of the storage area and disposable to releasably retain at least a portion of a second end of the ladder in a stored orientation.

9. The storage assembly as recited in claim 8 wherein said stored orientation is at least partially defined by said at least one securing member disposed in supporting relation to the second end of the ladder such that the ladder is substantially parallel to the support surface.

10. The storage assembly as recited in claim 1 wherein said at least one support member and said interior are cooperatively configured to permit rotational movement of the first end of the ladder supported on said at least one support member when moving between said access orientation and said stored orientation.

11. A ladder storage assembly comprising:
a plurality of support members collectively structured to removably support a first end of a ladder,
said plurality of support members comprising an interior dimensioned and configured to removably receive correspondingly disposed legs of the first end of the ladder,
a mounting member connected to a support surface of the storage area,
said plurality of support members connected in suspended, depending relation to said mounting member,
said plurality of support members movable relative to the support surface concurrent to supporting the legs of the first end of the ladder therein, and
said plurality of support members and the ladder selectively positionable between an access orientation and a stored orientation.

12. The storage assembly as recited in claim 11 wherein said plurality of support members are pivotally connected to said mounting member and structured to facilitate rotation of the first end of the ladder relative to the support surface between the access orientation and the stored orientation.

13. The storage assembly as recited in claim 12 further comprising a pivot mechanism having a plurality of pivot members interconnecting said support members to said mounting member.

14. The storage assembly as recited in claim 11 wherein at least one of said plurality of support members comprise an adjustment member disposed within said open interior thereof, said adjustment member disposable in confronting relation to a corresponding leg of the first end of the ladder and dimensioned to facilitate a fitting engagement therebetween

15. The storage assembly as recited in claim 11 wherein at least two of said support members comprise an interior dimensioned to removably receive a different leg of the first end of the ladder therein.

16. The storage assembly as recited in claim 15 wherein each of said two support members are pivotally connected to said mounting member and selectively movable concurrently with the first end of the ladder between said access orientation and said stored orientation.

17. The storage assembly as recited in claim 15 wherein each of said two support members comprise an adjustment member disposed within said open interior thereof, said adjustment member disposable in confronting relation to a corresponding leg of the first end of the ladder and dimensioned to facilitate a fitting engagement therebetween.

18. The storage assembly as recited in claim 11 further comprising at least one retention member movably attachable to the first end of the ladder and cooperatively disposed to restrict detachment of the legs of the first end of the ladder from said support members.

19. The storage assembly as recited in claim 11 further comprising at least one securing member connected in depending relation to the support surface of the storage area and disposable to releasably retain at least a portion of a second end of the ladder in a stored orientation.

20. The storage assembly as recited in claim 18 further comprising a plurality of securing members each disposable to releasably retain different portions of the second end of the ladder.

21. A method for storing a ladder, comprising:
inserting a first end of the ladder to be stored into an interior of at least one support member of a ladder storage assembly attached to an upper support surface,
positioning the first end of the ladder on the at least one support member in an access orientation,
maneuvering the ladder to be substantially parallel to the upper support surface, and
securing a second end of the ladder in a stored orientation.

22. The method as recited in claim 21 wherein positioning the first end of the ladder in an access orientation comprises orienting the ladder in an angled orientation relative to the upper support surface.

23. The method as recited in claim 21 wherein maneuvering the ladder comprises rotating the first end of the ladder within the ladder storage assembly.

24. The method as recited in claim 21 wherein securing the second end of the ladder a stored orientation comprises securing the second end of the ladder to the upper support surface.

25. The method as recited in claim 21 wherein securing the second end comprises securing the second end of the ladder in adjacent relation to the upper support surface.
